(19) United States
(12) Patent Application Publication
(10) Pub. No.: US 2025/0205894 A1
(43) Pub. Date: Jun. 26, 2025

(54) SYSTEM AND METHOD FOR 3D SHAPE FORMATION

(71) Applicant: Aloysious Zziwa, Los Angeles, CA (US)

(72) Inventor: Aloysious Zziwa, Los Angeles, CA (US)

(21) Appl. No.: 18/741,249

(22) Filed: Jun. 12, 2024

Related U.S. Application Data
(60) Provisional application No. 63/612,706, filed on Dec. 20, 2023.

(51) Int. Cl. B25J 9/16; B25J 9/10; G05D 1/69

(52) U.S. Cl. CPC B25J 9/1682; B25J 9/10; B25J 9/1674; G05D 1/69

(57) ABSTRACT

A system for 3-dimensional shape formation, maintenance, and movement by a swarm of electronic and programmable units based on preset or real-time computer instructions disseminated through gossip among the units in close proximity using attraction and repulsion forces. Some of the units are assigned roles to track the shape and movement instructions in a decentralized way to allow localized control, failure recovery and maintenance. These instructions are optimized to require as little processing or memory allocation as possible in the regular swarm unit usage while secure enough to prevent third-party compromise.

### CROSS-REFERENCE TO RELATED APPLICATIONS

This application claims priority from a U.S. Provisional Patent Appl. No. 63/612,706, filed on Dec. 20, 2023, which is incorporated herein by reference in its entirety.

### FIELD OF INVENTION

The present invention relates to the generation, maintenance, and movement of a 3-dimensional shape formed from similar replaceable units of one or more types in a swarm setup accomplished by computer instruction. In particular, these units move in close proximity by attraction or repulsion force without hardware guides or manual intervention.

### BACKGROUND

The formation of a specific shape from individual electronic units that are initially randomly arranged in space is an area of active interest in several industries, from entertainment to healthcare. The shape can be formed using computer instructions and can further follow the computer instructions to rearrange in a different shape. Such swarm shape formation is actively used in holograms, night-time drone formations, 3D glasses custom hardware, virtual-reality equipment, and many others.

With an increase in size or complexity of the shape to be formed, the process also becomes more complicated. Instructing and moving a large number of electronic units, such as drones and robots in a collision-free manner is a time-consuming, complex, costly, and exhaustive process. The electronic units consume a lot of processing power and energy to process the instructions, which makes the process very costly and complex. Conventional technologies require expensive equipment, large venue setups, specific lighting situations, and a lot of technical expertise for complex shape formations. Typically, an average person cannot afford such services for advertisements because of the high cost.

A need is therefore appreciated for a system and method that can overcome the aforesaid drawbacks.

### SUMMARY OF THE INVENTION

The following presents a simplified summary of one or more embodiments of the present invention to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a system and method for 3D shape formation with better user experience, speed, animations, and like features.

Another object of the present invention is that the method is user-friendly and reusable.

Still another object of the present invention is that the system and method can work in any lighting condition.

An object of the present invention is that the system can work without requiring any special staging, flight plans or direct involvement of the solution supplier every time it is to be used.

An object of the present invention is that the system may be sturdy enough to survive occasional misuse.

Yet another object of the present invention is that the system and method are safe enough to be independently operated within expected parameters and following its usage instructions.

An object of the present invention is that the system can be programmed by the user or follow their custom instructions for the shape to look or perform a certain way.

An object of the present invention is that the system can be used in places for various activities, such as outdoor advertisement, educational illustrations, prosthetics, movie props, fashion design illustrations, architecture models, and so much more.

In one aspect, the system includes a plurality of programmable units, also referred to herein as electronic units, which can be programmed to move in a swarm formation in close proximity following instructions generated from imperfect sources and passed along via gossip among each other. Given the limitations on the size and capability of the individual units, these instructions are structured to require as little processing as possible to be executed.

In one aspect, the programmable units may use magnetic forces to move relative to each other.

In one aspect, neighboring units mimic the behavior of other units, such as the surface units for shape formation, without doing the heavy processing themselves.

In certain implementations, disclosed are a plurality of programmable units moving in a swarm formation in close proximity following instructions generated from imperfect sources and passed along via gossip among each other. Given the limitations on the size and capability of the individual units, these instructions are structured to require as little processing as possible to be executed. In preferred embodiments, the programmable units use magnetic forces to move, and the neighboring units mimic the behavior of other units, such as the surface units for shape formation, without doing the heavy processing themselves.

### BRIEF DESCRIPTION OF DRAWINGS

The accompanying figures, which are incorporated herein, form part of the specification and illustrate embodiments of the present invention. Together with the description, the figures further explain the principles of the present invention and enable a person skilled in the relevant arts to make and use the invention.

FIGS. 1A and 1B show swarm message dissemination for broadcast and for a specific unit(s), according to an exemplary embodiment of the present invention.

FIG. 2 is a flowchart of coordinating in the dissemination of messages in the swarm using swarm units with a mother role (versus child role), according to an exemplary embodiment of the present invention.

FIGS. 3A & 3B demonstrate using REPLACE command to move a shape by the surface unit instructions, according to an exemplary embodiment of the present invention.

FIGS. 4A-4F illustrate a good swarm unit maneuvering around a bad/failed unit, according to an exemplary embodiment of the present invention.

FIGS. 5A-5D show sample shapes that a swarm unit could take with preferences based on overall shape size, according to an exemplary embodiment of the present invention.

FIG. 6 illustrates an exemplary simplified swarm unit placement map for a human shape to be animated, according to an exemplary embodiment of the present invention.

FIGS. 7A-7D demonstrate shape restoration by a sub-swarm such as from shape recovery of a lost limb, according to an exemplary embodiment of the present invention.

FIG. 8 is a block diagram showing the architecture of the disclosed system, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

Disclosed are a system and method for 3D shape formation using programmable/electronic units working in a swarm framework. The electronic units of the disclosed system can be programmed and instructed to move in a swarm formation. The system with its electronic devices has the advantage of handling instructions generated from imperfect sources, and thus requires lesser processing power, making the process easier and cost-effective. The instructions can be passed among the electronic units via gossip among each other. Given the limitations on the size and capability of the individual electronic units, these instructions are structured to require as little processing as possible to be executed. This is a critical feature of the invention that allows making the process quicker and more economical. The cost of the system can be significantly reduced since the child units of less processing power can be utilized. The child units need to process lesser instructions, compared to the mother units. Moreover, the whole process becomes less complex compared to conventional technologies.

In normal usage, commands can be generated, sent, and followed in real-time or on schedule time to organize a swarm of electronic units in close proximity to move, form a shape, or maintain a 3-Dimensional shape or change appearance through a given timeframe using forces created or maintained by the individual units to form the expected shape. The terminology “close proximity” is used herein to mean distances of less than half of the individual swarm unit dimensions.

The input for the shape can be any digital form of image, such as a video, line art, clip art, 3D representation of a model, and the like. The system from such an input source can determine intent, clean, prepare and predict missing data or instruction not explicitly entered and then create commands and send the same to the electronic units for the chosen shape formation. The system can perform extensive computations to generate the instructions for swarm shape representation 8, as well as its changes with time. These computations may include estimations from previous similar requests such as using Artificial Intelligence with learning algorithms.

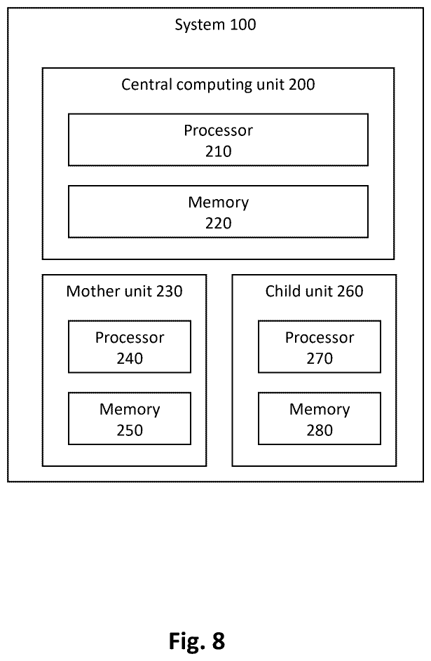

These commands can then be compressed and optimized for quick reading and processing by the electronic/swarm units 1, 2. The electronic units in one implementation can be Internet-of-Things (IoT) computational systems that can receive wireless commands 3 from a central computing unit. FIG. 8 is a block diagram showing the architecture of the disclosed system 100. System 100 includes central computing units 200, mother units 230, and child units 260. The central computing units include a processor 210 and a memory 220.

The mother units include a processor 240 and memory 250. The child units include a processor 270 and memory 280. The mother units and the child units can be loT devices that can form the shape while the central computing units can generate instructions and transmit the same to the mother units or the mother and child units. The information can be shared among the mother units and the child units through a gossip method. Thus, the electronic units including the mother units and child units, can receive the instructions and process the same to follow the outlined steps of the disclosed method for shape formation. In certain implementations, the instructions can be encrypted to avoid mid-transmission access by third parties or corruption before reaching their destination.

The commands are then broadcast 4, 9 to the units in the swarm assigned the mother role 1. Some units in the swarm can be set up as mother units. The commands from the central computing unit can be broadcast to the mother units. The mother units may have higher than average processing power and memory capacity to handle the intensity and speed required for handling large shape data sets and producing appropriate instructions in time for the child units to follow. For simple animations or shapes, they can contain the full routine and do not require further input from the instructing program 5 for the swarm shape to operate.

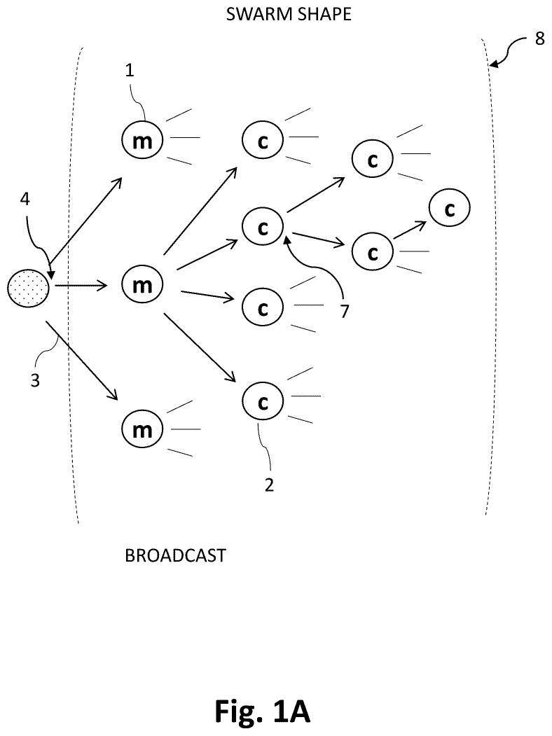

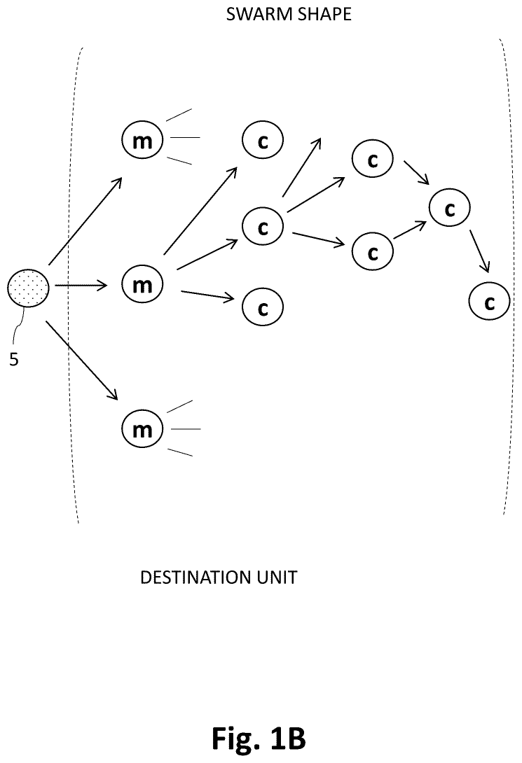

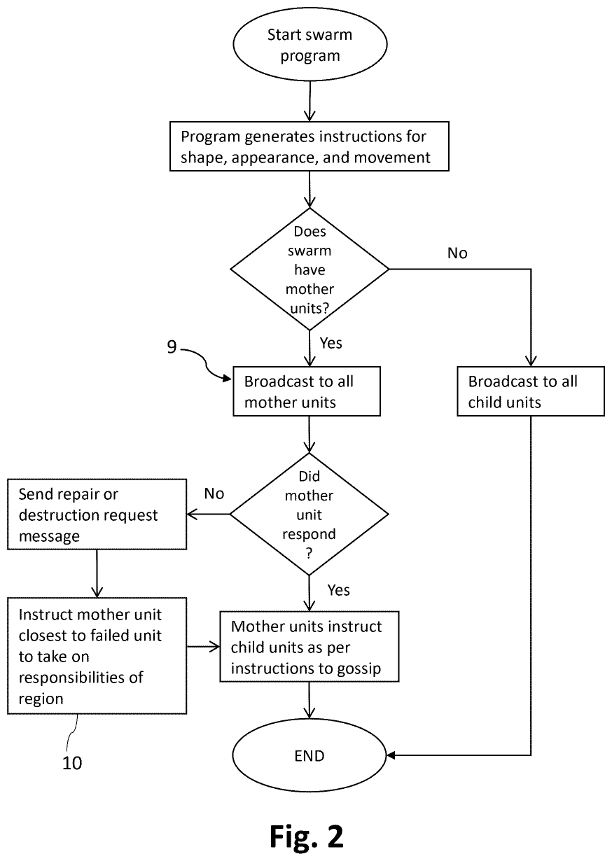

FIG. 1A shows an example of broadcasting instructions from a central computing unit to mother units. From the mother units, the information can be shared with the child units, and among the child units through gossip methods. Thus, in the gossip method, the child units may not need to process huge information datasets, but only receive relevant discrete instructions as messages and process the same, and at the same time relay the message to other child units as gossip.

In cases where there are no units assigned to the mother role in the swarm, especially for small swarms, the commands can be broadcast directly to the neighboring child units 2 which spreads the command message via gossip 7 among each other. FIG. 1A shows the central computing unit that sends the instructions to a few child units, and the instructions spread to other child units as gossip.

To reduce instances of processing overload, when old messages are gossiped, the messages are assigned lifetimes based on either the number of hops to get to their destination or the expected time to last after generation-using the estimated duration before reaching the message destination as a guide. This ensures that late messages that are no longer relevant are ignored to avoid errors that may affect the synchronization of other units. Table 1 includes samples of such discrete instructions.

Due to a number of factors, including environmental, errors in programming, or unit breakdown, failures are normal in a swarm. Therefore, they can be planned for so that recovery processes can be executed in near real time. As an example, if a mother unit fails to respond to a broadcast message, the closest mother unit is instructed to take on its tasks 10 until it is recovered or replaced. This is possible because swarm units can be operated in a decentralized format and failure of one does not necessarily affect the operation of the other.

Also, in a similar consideration, if a child unit is no longer responsive to movement or other appropriate commands, 11 the neighboring child units can a) move around the unresponsive unit to continue with their path as programmed 12 or b) push the unresponsive unit to a “dead zone” to unblock the path of the other units. This push action requires the acting unit to have the “carrier” mode enabled which means that the unit has the capability to make a forced and fixed connection with the unresponsive unit and, in one embodiment, override its magnetic coils to enable push and pull forces on the unresponsive unit with the guidance of the carrier unit.

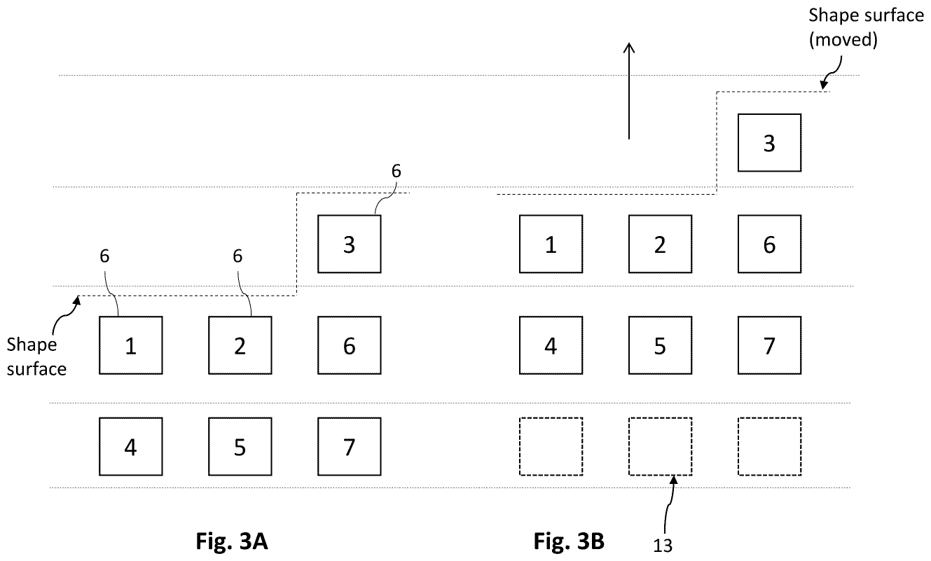

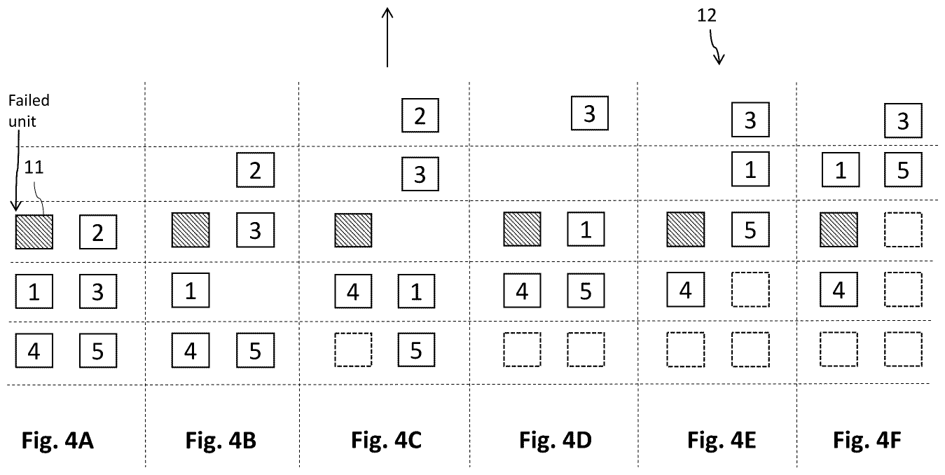

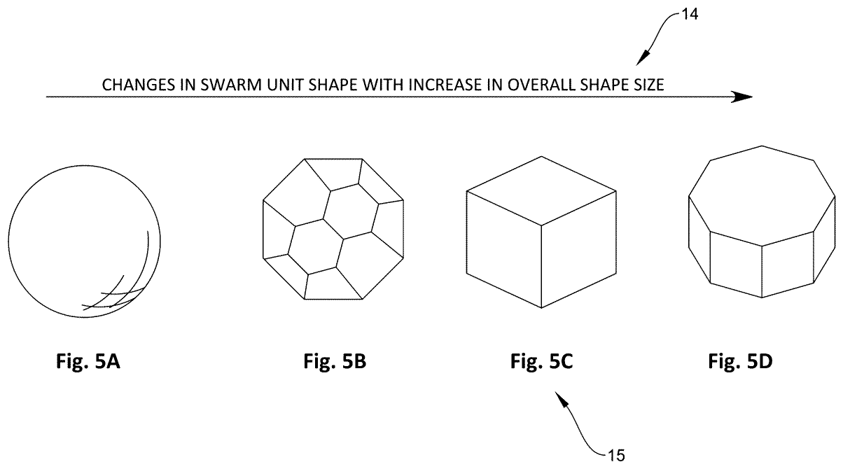

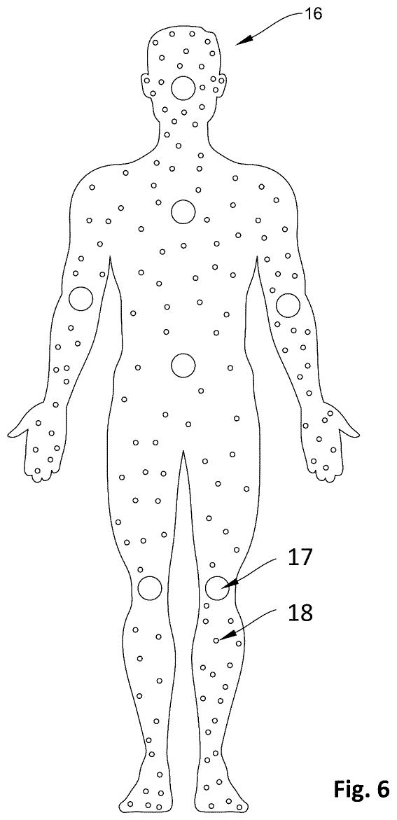

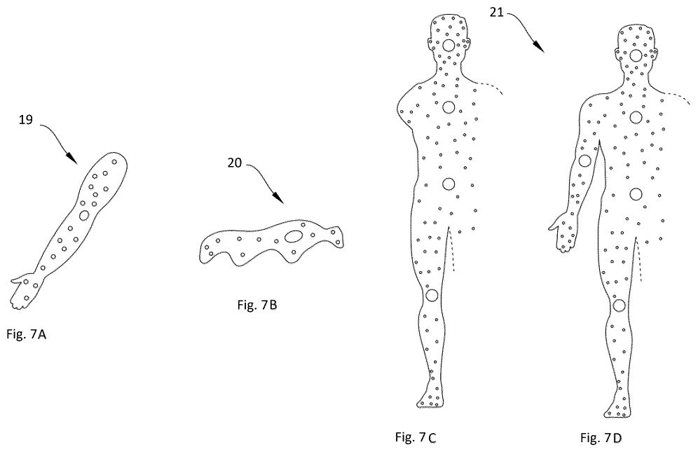

Referring to FIGS. 3A and 3B, to reduce processing requirements on the child units, a mother unit may use primed units to instruct their neighbors on their next actions. As an example, instead of sending a move instruction to all swarm units in a location, the mother unit could identify the units on the surface as the primed units, units 6 in FIGS. 3A and 3B. When the move instruction is sent to these units, the units are primed to instruct the neighbors along the path of their destination to replace them at their current location when they move 13. This is a faster way to move the entire shape while requiring fewer messages sent out to all units. In addition, each internal unit needs less processing to compute the path and direction of the swarm shape based on the destination coordinates as the internal unit is only concerned about moving one hop to its next location. The same approach is used in many various situations such as charging, repairing, disassembly of shape or cleaning units, among others.

In addition, when a swarm shape is determined, the expected size, appearance, and performance requirements dictate, to an extent, the swarm unit size, capabilities, and building requirements. One of the parameters that undergo change with significant variation in size of the overall swarm shape is the actual shape of the swarm unit 14. Among other considerations, the shape affects the degrees of motion of the unit, maneuverability, and carrying capacity and thus has to be carefully considered when determining the overall swarm capabilities. Therefore, as the overall shape gets bigger, the individual unit gets bigger, and its shape is adjusted 15 to ease movement and maintain swarm shape appearance expectations.

For relatively large or complex swarm shapes such as a real-size human shape 16, decentralized sub-swarms are introduced to manage local shape instruction handling and dissemination. These sub-swarms are capable of operating in the overall shape or independently in case of loss of shape cohesion 19. For example, FIG. 6 shows a swarm shape 16 resembling an adult human body outline. The bigger circles in the shape are mother units 17 and the small circles indicate child units 18. The mother unit with the neighboring child units forms a sub-swarm. For example, the head outline, limbs, and sub-swarms form chest, abdomen, and the like.

In such instances, the sub-swarm will revert to a preprogrammed routine to return to the main swarm body, such as by reshaping and moving in a format 20 that directs the shape to the previously known location of the main swarm or, if that fails, the swarm homing unit.

When the sub-swarm reaches the main swarm, in one consideration, it is checked for external tampering using pre-programmed checks with encryption key matches and then synchronized with the main swarm 21. After this, it is either a) “absorbed” in the main swarm mass and another neighboring sub-swarm instructed to replace the lost “limb” or b) redirected through a “fast-lane” internal path to return to its previous location. The latter option is usually preferred if the sub-swam contains many specialized units that have specific requirements for the “limb” in question and cannot be easily replaced by neighboring swarm units.

To achieve the movements, coordination, and reliability expected of the shape, the swarm units use coded instructions as described in a sample list of Table 1 to speed up command recognition and resource allocation in the unit and swarm. These codes also hint at the intended recipient of the command so that the handling of the message is further sped up by skipping read or extraction procedures for incompatible messages for the unit in question. As an example, if a child unit receives a SHAPE instruction 21 meant for the mother unit and the swarm is set to have units with the mother role, it can safely ignore the instruction reading and simply pass it on.

All in all, although the present invention has been illustrated and described herein with reference to preferred embodiments and specific examples thereof, it will be readily apparent to those of ordinary skill in the art that other embodiments and examples may perform similar functions and/or achieve like results. Thus, all such equivalent embodiments and examples are within the spirit and scope of the present invention, are contemplated thereby, and are intended to be covered by the following claims.

Table 1 shows a list of sample commands that can be shared in messaging among the units during shape formation, maintenance, and movement.

TABLE 1
List of sample commands:

| No. | Code | Explanation | Sample |
|---|---|---|---|
| 1.3.1 | PUSH*¹ | Send a magnetic field in the direction of the given | push = [x~8652446466 · |
| | | position to repel the requesting particle | y~7234230999 · z~4789745578] |
| 1.3.2 | PULL*¹ | Send a magnetic field in the direction of the given | pull = [x~8652446466 · |
| | | position to attract the requesting particle | y~7234230999 · z~4789745578] |
| 1.3.3 | HOLD | Increase length of extension in female socket nearest to | hold = [x~8652446466 · |
| | | the direction of the given position | y~7234230999 · z~4789745578] |
| 1.3.4 | RELEASE | Reduce length of extension in female socket nearest to | release = [x~8652446466 · |
| | | the direction of the given position | y~7234230999 · z~4789745578] |
| 1.3.5 | STATUS | Update on the status of a particle. Valid status codes | status = [motion_state = moving, |
| | | include: | role = child, |
| | | power_level: [percentage], charging, overload | container_id = rgb_808982344, |
| | | motion_state: fixed, moving, set | on_surface = n, activity = busy] |
| | | role: mother, child, carrier | |
| | | activity: busy, idle, error | |
| | | container_id: [unique id of container on chip] | |
| | | on_surface: y~[side], n | |
| 1.3.6 | LOCATION | The 3-dimensional coordinates of the particle in relation | location = [x = 8652446466, |
| | | to the origin coordinates in nm | y = 7234230999, |
| | | | z = 4789745578] |
| 1.3.7 | TASK | Usually sent by a mother particle or home pod. The task | task = [do_role = child, |
| | | is to perform a list of instructions to fulfill an overall goal | power_mode = high, |
| | | of the shape. Valid instruction codes include: | move = x~8652446466 · |
| | | move | y~7234230999 · z~4789745578 \| |
| | | power_mode | x~8562446466 · y~7231130999 · |
| | | do_container | z~4789745000, |
| | | do_role | do_container = r~64 · g~120 · |
| | | fix_position | b~80, power_mode = low, |
| | | | fix_position = n] |
| 1.3.8 | SHAPE | The shape being maintained by the particle. Given the | shape = [id = 3567535366, |
| | | memory requirements of this message, it's only sent | in_motion = y, |
| | | when there are changes to the shape or parts of the | bounds = x~8652446466 · |
| | | shape are in motion. For complex shapes, only the | y~7234230999 · z~4789745578 \| |
| | | bounds of the expected region of motion of the particle | x~8562446466 · y~7231130999 · |
| | | are shared with it. | z~4789745000 \| . . .] |
| 1.3.9 | ORIGIN | The origin coordinates around which the shape is | origin = [x = 8652446466, |
| | | assembled. This value only actively changes for a shape | y = 7234230999, |
| | | in motion. | z = 4789745578] |
| 1.3.10 | NEIGHBOR | Broadcast message by a particle to inform neighboring | neighbor = [id = z8907878234, |
| | | particles of its presence or leaving. | direction = in] |
| 1.3.11 | GOSSIP | Share a message with neighbors or with a given particle. | gossip = [for = z4447811231, |
| | | If a message is for a specified particle which is not a | hops_remaining = 95, |
| | | neighbor of the particle and its remaining hops are not | message = [task = [do_role = child, |
| | | zero, it is simply passed on to the neighbors of the | power_mode = overload, |
| | | particle in its possession. | fix_position = y]]] |
| 1.3.12 | REPLACE | A departing particle instructs a neighbor to move and | replace = [x = 8652446466, |
| | | replace it in its previous position. This ensures that | y = 7234230999, |
| | | moving a whole shape requires the mother particle(s) or | z = 4789745578] |
| | | pod to simply instruct the particles on the surface and | |
| | | the rest of the particles will maintain the desired shape | |
| | | in motion. | |
| 1.3.13 | PASS | A particle behind a blocked path can request to pass a | pass = [x = 8652446466, |
| | | neighboring particle to continue on its journey by | y = 7234230999, |
| | | passing its current coordinates. This may cause the | z = 4789745578] |
| | | passed particle to instruct its neighbors to wait to launch | |
| | | their next movement instruction. | |
| 1.3.14 | WAIT | A particle that needs its neighbor(s) to wait to launch | wait = [x = 8652446466, |
| | | their next movement can inform them by passing its | y = 7234230999, |
| | | location | z = 4789745578] |
| 1.3.15 | CARRY | A particle requests another particle to carry it to a | carry = [x = 8652446466, |
| | | destination. It can send its current location as a distress | y = 7234230999, |
| | | signal with a carry code, if say, its low on power and | z = 4789745578] |
| | | needs to be taken to one of its designated charging | |
| | | nodes in the swarm. This involves making a fixed | |
| | | connection and doubling the internal computation for | |
| | | length of the carrier unit and allowing overrides for the | |
| | | circuits for the movement coils of the unit being carried. | |

*¹The particle requesting always runs the current in the coil to position the magnetic field north in the direction of the party it requested. The particle receiving the request can either position north (for repel) or south (for attract) in the direction of the requesting party by changing the flow of the current in the coil.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A method for 3D swarm shape formation, recovery, and movement, the method comprising:
generating, an instruction set for swarm shape formation using one or more central units, wherein the instruction set comprises shaping and movement instructions;
receiving the instruction set from the one or more central units, by each of a plurality of mother units;
transmitting discrete instructions by the plurality of mother units to one or more child units of a plurality of child units,
wherein each of the plurality of mother units and one or more child units is a swarm unit that is replaceable, wherein similar swarm units move in close proximity.

2. The method of claim 1, wherein the method further comprises:
receiving, by the one or more central units, an input for the swarm shape formation, wherein the input comprises 2- or 3-dimensional graphic or animation, wherein the one or more central units are configured to process the input to predict missing parts of the instruction set to produce a complete 3-dimensional shape and its movement coordinates.

3. The method of claim 1, wherein the method further comprises:
compressing, the instruction set by removal of predictable or irrelevant information based on its destination.

4. The method of claim 3, wherein the method further comprises:
encrypting, the instruction set using a plurality of keys for relay and processing, wherein the plurality of keys are known by the plurality of mother units and/or one or more child units.

5. The method of claim 4, wherein each of the swarm units is configured for at least one role from a plurality of roles, wherein the plurality of roles comprises disseminating local instructions and receiving the local instructions.

6. The method of claim 4, wherein the plurality of roles further comprises transporter, carrier, charger, destroyer,
wherein a swarm unit in the role of the transporter is configured for moving resources in the swarm shape formation, wherein the resources comprise fuel and payload;
wherein a swarm unit in the role of the carrier is configured to pull a failed swarm unit during the swarm shape formation, towards a storage, disposal container, or a swarm dead-zone location;
wherein a swarm unit in the role of the charger is configured to collect energy more effectively for usage or sharing with other swarm units,
wherein a swarm unit in the role of the destroyer is configured to safely eliminate or neutralize compromised or failed swarm units during the swarm shape formation.

7. The method of claim 1, wherein the discrete instructions are relayed by gossip among the swarm units.

8. The method of claim 7, wherein the relayed by gossip comprises broadcasting or sending a message to a specific swarm unit of the swarm units.

9. The method of claim 8, wherein the message is conjured to automatically decay based on hops or time since generation.

10. The method of claim 1, wherein the method further comprises:
enabling non-surface swarm units inferring their movement or other instructions from primed swarm units, wherein the primed swarm units comprise shape's surface swarm units.

11. The method of claim 1, wherein the method further comprises:
allowing good swarm units of the swarm units to maneuver around failed or compromised swarm units of the swarm units.

12. The method of claim 5, wherein the method further comprises:
instructing one or more swarm units of the swarm units to maintain a set position in case of power loss or intentional power-down.

13. The method of claim 1, wherein the method further comprises:
detecting a corrupt message; and
upon detecting the corrupt message, repairing or discarding the corrupt message based on intent and recovery results.

14. The method of claim 1, wherein two or more mother units of the plurality of mother units are configured for maintaining shaping instructions in a decentralized way.

15. The method of claim 14, wherein a mother unit of the two or more mother units is configured to provide localized shaping instructions to the one or more child units as a sub-swarm in an overall swarm shape formation.

16. The method of claim 14, wherein the method further comprises:
taking, by a mother unit of the plurality of mother units, role of another mother unit of the plurality of mother unit in case the another mother unit fails or gets compromised.

17. The method of claim 8, wherein the method further comprises:
reporting, by a swarm unit, a neighboring swarm unit, wherein the neighboring swarm unit is in neighbour of the swarm unit and the neighboring swarm unit has failed or compromised, wherein the reporting is for avoidance, repair, or disposal.

18. The method of claim 3, wherein the step of compressing further comprises:
summarizing path information for expected unit routes.

19. The method of claim 18, wherein the step of compressing further comprises:
enabling unit recovery from loss or corruption of part of the instruction.

20. The method of claim 15, wherein the sub-swarm is configured to operate independent of a main shape swarm in case of separation, wherein the method further comprises:
returning of the sub-swarm, by following preset instructions, to the main shape swarm or a homing pod.

21. The method of claim 1, wherein the swarm units move relative to each other using attraction and repulsion forces, wherein the attraction and repulsion forces are created using magnetic fields and/or swarm medium manipulation.
